(19) United States
(12) Patent Application Publication
(10) Pub. No.: US 2016/0156854 A1
(43) Pub. Date: Jun. 2, 2016

(54) IMAGE PROCESSING METHOD AND APPARATUS, AND ELECTRONIC DEVICE

(71) Applicants: Shuangxin YANG, Beijing (CN); Xuefei CHEN, Beijing (US)

(72) Inventors: Shuangxin YANG, Beijing (CN); Xuefei CHEN, Beijing (US)

(73) Assignee: Sony Coporation, Tokyo (JP)

(21) Appl. No.: 14/654,874

(22) PCT Filed: Dec. 24, 2014
(86) PCT No.: PCT/IB2014/067300

§ 371 Date: Jun. 23, 2015

(30) Foreign Application Priority Data
Apr. 3, 2014 (CN) 201410133156.7

(51) Int. Cl. H04N 5/272; G06K 9/62; G06K 9/00

(52) U.S. Cl. CPC H04N 5/272; G06K 9/00228; G06K 9/6201

(57) ABSTRACT

The embodiments of the present application provide an image processing method, an image processing apparatus, and an electronic device. The image processing method includes: generating an image of an object by shooting the object with an image generation element; acquiring information of a shooter when the object is shot; and merging the information of the shooter into the image of the object to generate an image having the information of the shooter and information of the object. Through the embodiments of the present application, not only the information of the shooter and the object can be acquired, but also repetitive operations such as the user authentication can be reduced, thereby achieving better user experience.

### CROSS REFERENCE TO RELATED APPLICATIONS

This application claims priority from Chinese patent application No. 201410133156.7, filed Apr. 3, 2014, the entire disclosure of which hereby is incorporated by reference.

### TECHNICAL FIELD

The present application relates to image processing technologies, and particularly, to an image processing method, an image processing apparatus, and an electronic device.

### BACKGROUND ART

With the population of portable electronic devices (e.g., a digital camera, a smart phone, a tablet computer, etc.), the shooting of an image or a video gets easier and easier.

Currently, the camera technology in the portable electronic device becomes increasingly mature, and an object may be shot by setting various modes or parameters. For example, a shooting mode such as single shoot or continuous shoot may be selected; a scene mode such as landscape or portrait may be selected; or parameters such as brightness, saturation and white balance of the object may be adjusted. Through the settings made in the shooting process, the object can be sufficiently presented in the generated image of the object.

To be noted, the above introduction to the technical background is just made for the convenience of clearly and completely describing the technical solutions of the present application, and to facilitate the understanding by a person skilled in the art. It shall not be deemed that the above technical solutions are known to a person skilled in the art just because they have been illustrated in the Background section of the present application.

### SUMMARY

However, the inventor finds that in many cases, the shooter is usually omitted in the shooting process, and it is difficult to remember the creator of each picture. For example, there may be several users for a smart phone, and each user may make a shooting, thus it is difficult to distinguish the shooter of each picture stored in the picture gallery. Even if in a multi-user supported smart phone platform, user authentication is still required for each user before the user makes a shooting, which causes a lot of tedious and repetitive operations, and better user experience cannot be achieved.

The embodiments of the present application provide an image processing method, an image processing apparatus, and an electronic device, by adding the information of the shooter into the image of the object, the information of the shooter and the object can be reflected by each image of the object, thereby reducing a lot of tedious and repetitive operations, and achieving better user experience.

According to a first aspect of the embodiments of the present application, an image processing method is provided, including:
generating an image of an object by shooting the object with an image generation element;
acquiring information of a shooter when the object is shot; and
merging the information of the shooter into the image of the object to generate an image having the information of the shooter and information of the object.

According to a second aspect of the embodiments of the present application, the image generation element is a first camera, and the information of the shooter is acquired through a second camera.

According to a third aspect of the embodiments of the present application, the acquiring the information of the shooter when the object is shot includes:
performing face recognition of the shooter to acquire face information of the shooter; and comparing the face information of the shooter with pre-stored face information to acquire the information of the shooter according to a comparison result;
or, performing voice recognition of the shooter to acquire audio information of the shooter; and comparing the audio information of the shooter with pre-stored audio information to acquire the information of the shooter according to a comparison result;
or, recognizing the shooter's usage habit to acquire the shooter's usage habit information; and comparing the shooter's usage habit information with pre-stored usage habit information to acquire the information of the shooter according to a comparison result.

According to a fourth aspect of the embodiments of the present application, the information of the shooter includes one or any combination of the shooter's identity, the shooter's name, the shooter's link information, the shooter's social network information and the shooter's personalized settings.

According to a fifth aspect of the embodiments of the present application, after the acquiring the information of the shooter when the object is shot, the image processing method further includes:
displaying the information of the shooter on a viewfinder.

According to a sixth aspect of the embodiments of the present application, the image processing method further includes:
activating the shooter's personalized settings to acquire a personalized-processed image of the object.

According to a seventh aspect of the embodiments of the present application, the merging the information of the shooter into the image of the object to generate an image having the information of the shooter and information of the object includes:
adding the information of the shooter into an Exchangeable Image File (EXIF) of the image of the object; or
adding the information of the shooter into an EXIF of the image of the object, and embedding an image of the shooter acquired by the second camera into the image of the object.

According to an eighth aspect of the embodiments of the present application, after the merging the information of the shooter into the image of the object to generate an image having the information of the shooter and information of the object, the image processing method further includes:
classifying or sorting the image according to the information of the shooter.

According to a ninth aspect of the embodiments of the present application, the image processing method further includes:
recognizing the object to acquire the information of the object.

According to a tenth aspect of the embodiments of the present application, the image processing method further includes:
sending the information of the shooter and the information of the object to a server, so as to establish the shooter's link information or establish associations between a plurality of shooters who shoot the object in the server.

According to an eleventh aspect of the embodiments of the present application, an image processing apparatus is provided, including:
an image acquiring unit, configured to generate an image of an object by shooting the object with an image generation element;
an information acquiring unit, configured to acquire information of a shooter when the object is shot; and
an information merging unit, configured to merge the information of the shooter into the image of the object to generate an image having the information of the shooter and information of the object.

According to a twelfth aspect of the embodiments of the present application, the image generation element is a first camera, and the information acquiring unit acquires the information of the shooter through a second camera.

According to a thirteenth aspect of the embodiments of the present application, the information acquiring unit is configured to perform face recognition of the shooter to acquire face information of the shooter, and compare the face information of the shooter with pre-stored face information to acquire the information of the shooter according to a comparison result;
or, perform voice recognition of the shooter to acquire audio information of the shooter; and compare the audio information of the shooter with pre-stored audio information to acquire the information of the shooter according to a comparison result;
or, recognize the shooter's usage habit to acquire the shooter's usage habit information; and compare the shooter's usage habit information with pre-stored usage habit information to acquire the information of the shooter according to a comparison result.

According to a fourteenth aspect of the embodiments of the present application, the image processing apparatus further includes:
a display unit, configured to display the information of the shooter on a viewfinder.

According to a fifteenth aspect of the embodiments of the present application, the image processing apparatus further includes:
an activation unit, configured to activate the shooter's personalized settings to acquire a personalized-processed image of the object.

According to a sixteenth aspect of the embodiments of the present application, the information merging unit is configured to add the information of the shooter into an Exchangeable Image File (EXIF) of the image of the object; or add the information of the shooter into an EXIF of the image of the object, and embed an image of the shooter acquired by the second camera into the image of the object.

According to a seventeenth aspect of the embodiments of the present application, the image processing apparatus further includes:
a classifying unit, configured to classify or sort the image according to the in- formation of the shooter.

According to an eighteenth aspect of the embodiments of the present application, the image processing apparatus further includes:
an object recognition unit, configured to recognize the object to acquire the information of the object.

According to a nineteenth aspect of the embodiments of the present application, the image processing apparatus further includes:
an information sending unit, configured to send the information of the shooter and the information of the object to a server, so as to establish the shooter's link information or establish associations between a plurality of shooters who shoot the object in the server.

According to a twentieth aspect of the embodiments of the present application, an electronic device is provided, including the aforementioned image processing apparatus.

The embodiments of the present application have the following beneficial effect: by adding the information of the shooter into the image of the object, the information of both the shooter and the object can be conveniently acquired, thereby reducing a lot of tedious and repetitive operations, and achieving better user experience.

These and other aspects of the present application will be clear with reference to the subsequent descriptions and drawings, which disclose the particular embodiments of the present application to indicate some implementations of principles of the present application. But it shall be appreciated that the scope of the present application is not limited thereto, and the present application includes all the changes, modifications and equivalents falling within the scope of the spirit and the connotations of the accompanied claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

Many aspects of the present application will be understood better with reference to the following drawings. The components in the drawings are not surely drafted in proportion, and the emphasis lies in clearly illustrating principles of the present application. For the convenience of illustrating and describing some portions of the present application, corresponding portions in the drawings may be enlarged, e.g., being more enlarged relative to other portions than the situation in the exemplary device practically manufactured according to the present application. The parts and features illustrated in one drawing or embodiment of the present application may be combined with the parts and features illustrated in one or more other drawings or embodiments. In addition, the same reference signs denote corresponding portions throughout the drawings, and they can be used to denote the same or similar portions in more than one embodiment.

### BRIEF DESCRIPTION OF DRAWINGS

The accompanying drawings are included to provide further understanding of the present application, and they constitute a part of the Specification. Those drawings illustrate the preferred embodiments of the present application, and explain principles of the present application with the descriptions, wherein the same element is always denoted with the same reference sign.

In the drawings,

FIG. 1 is a flowchart of an image processing method according to Embodiment 1 of the present application;

FIG. 2 is another flowchart of an image processing method according to Embodiment 1 of the present application;

FIG. 3 is still another flowchart of an image processing method according to Embodiment 1 of the present application;

FIG. 4 is a diagram of an example of acquiring information of the shooter according to Embodiment 1 of the present application;

FIG. 5 is a flowchart of an image processing method according to Embodiment 2 of the present application;

FIG. 6 is a schematic diagram of the structure of an image processing apparatus according to Embodiment 3 of the present application;

FIG. 7 is another schematic diagram of the structure of an image processing apparatus according to Embodiment 3 of the present application;

FIG. 8 is still another schematic diagram of the structure of an image processing apparatus according to Embodiment 3 of the present application;

FIG. 9 is a schematic diagram of the structure of an image processing apparatus according to Embodiment 4 of the present application; and

FIG. 10 is a block diagram of a system construction of an electronic device according to Embodiment 5 of the present application.

### DESCRIPTION OF EMBODIMENTS

The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus, etc.

In the present application, the embodiments of the present application are mainly described with respect to a portable electronic apparatus in the form of a mobile phone (also referred to as “cellular phone”). However, it shall be appreciated that the present application is not limited to the case of the mobile phone and it may relate to any type of appropriate electronic device, such as media player, gaming device, PDA, computer, digital camera, tablet computer, wearable electronic device, etc.

### Embodiment 1

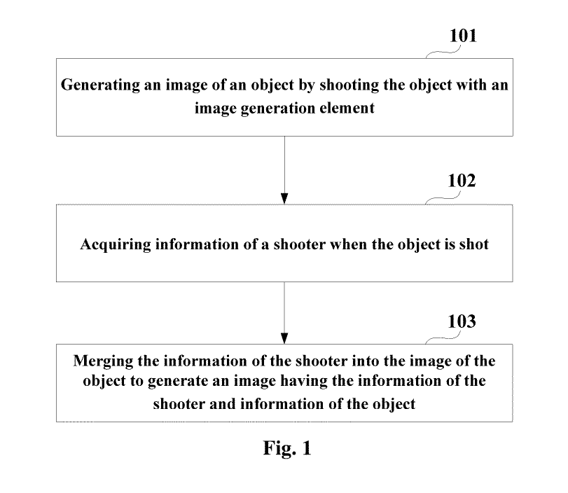

The embodiment of the present application provides an image processing method. FIG. 1 is a flowchart of an image processing method according to Embodiment 1 of the present application. As illustrated in FIG. 1, the image processing method includes:
step 101: generating an image of an object by shooting the object with an image generation element;
step 102: acquiring information of a shooter when the object is shot;
step 103: merging the information of the shooter into the image of the object to generate an image having the information of the shooter and information of the object.

In this embodiment, the image processing method may be carried out through an electronic device having an image generation element, which may be integrated into the electronic device, and which for example may be a rear camera of a smart phone. The electronic device may be a mobile terminal, such as a smart phone or a digital camera, but the present application is not limited thereto. The image generation element may be a camera or a part thereof, and the image generation element may also be a lens (e.g., single lens reflex) or a part thereof, but the present application is not limited thereto. Please refer to the relevant art for the image generation element.

In addition, the image generation element may be removably integrated with the electronic device through an interface, or connected to the electronic device wiredly or wirelessly such as being controlled by the electronic device through WiFi, Bluetooth or Near Field Communication (NFC). The present application is not limited thereto, and the image generation element may be connected to and controlled by the electronic device in other ways.

In this embodiment, the information of the shooter can be acquired when the object is shot. For example, the information of the shooter can be acquired in real time with a camera. But the present application is not limited thereto, and the information of the shooter can be acquired in other ways, such as using sound recognition. Thus, not only information of the shooter and the object can be reflected, but also a lot of tedious and repetitive operations such as user authentication can be reduced, thereby achieving better user experience.

To be noted, the image processing method in the embodiment of the present application is suitable for shooting not only static images such as photos, but also dynamic images such as video images. That is, information of the shooter of a video can also be added into the video file, to generate a video having the information of the shooter and the information of the object.

In addition, in this embodiment, the shooter may be one or more persons. For example, a video may be shot by several shooters in turn. A plurality of information of the shooter can be acquired when the object is shot, and then added into the image of the object, but the present application is not limited thereto.

During an implementation, priorities may be set for a plurality of shooters. For example, a shooter with the longest shooting time has the highest priority, and a shooter with the shortest shooting time has the lowest priority. When being displayed on a viewfinder as described later, the shooters may be displayed discriminatively in the order of priorities. For example, the shooter having the highest priority is displayed at the most left, or using a different font or color. The present application is not limited thereto, and the detailed application mode can be determined according to the actual scene.

In this embodiment, the information of the shooter includes one or any combination of the shooter's identity (e.g., registered icon), the shooter's name, the shooter's link information, the shooter's social network information and the shooter's personalized settings. But the present application is not limited thereto, and other information of the shooter may also be included, which is determined according to the actual scene.

For example, the shooter's registered icon may include the shooter's face, or an object, pattern or landscape related to the shooter, or any other image. The shooter's name may be the shooter's name or registered nickname. The shooter's personalized settings may be the shooter's shooting preferences, such as deactivating the flashlight, activating the High-Dynamic Range (HDR) mode, prohibiting the shutter sound, etc.

For example, the shooter's link information may link the shooter's personal website, the commercial website, etc. A function similar to advertisement can be realized through the link information to provide other users with a link path for knowing the shooter. The social network information of the shooter for example may be a Facebook account, an MSN account, a WeChat account, a cellular phone number, a QQ number and an email address, through which the contact information of the shooter may be provided to other users.

In one example of this embodiment, the image generation element is a rear camera (a first camera) of the electronic device, through which the object is shot to generate an image of the object. The electronic device may also have a front camera (a second camera), through which the information of the shooter is acquired. That is, by using the existing double cameras and the face recognition technology, the information of the shooter can be acquired while the image of the object is shot.

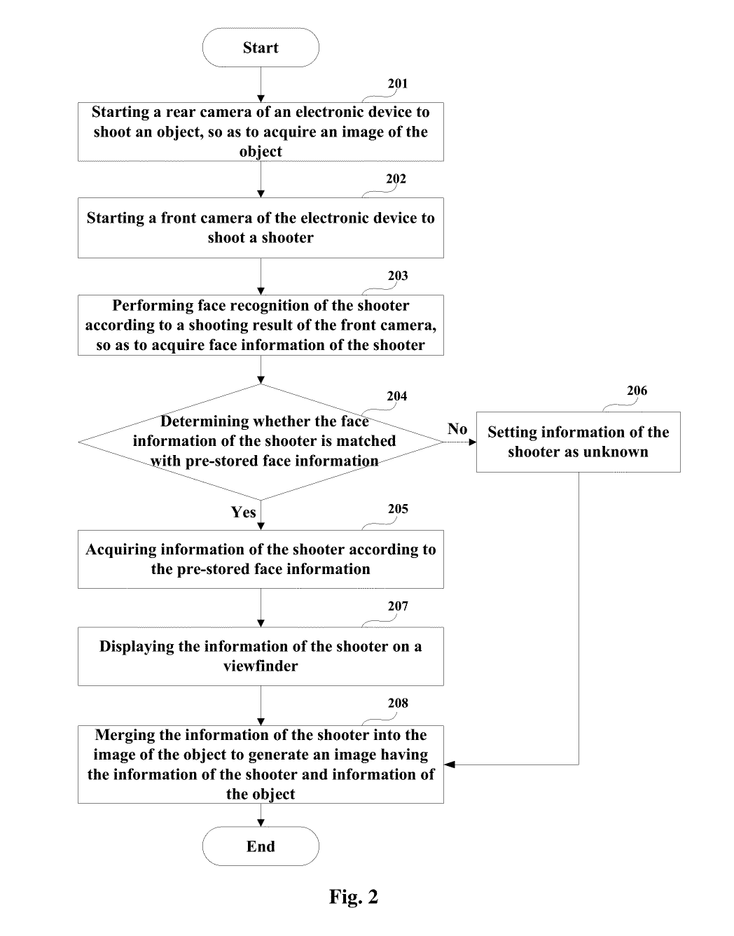

FIG. 2 is another flowchart of an image processing method according to Embodiment 1 of the present application. As illustrated in FIG. 2, the image processing method includes:
step 201: starting a rear camera of an electronic device to shoot an object, so as to acquire an image of the object;
step 202: starting a front camera of the electronic device to shoot a shooter;
step 203: performing face recognition of the shooter according to a shooting result of the front camera, so as to acquire face information of the shooter;
step 204: comparing the face information of the shooter with pre-stored face information; and if they are matched, performing step 205, otherwise performing step 206;
step 205: acquiring information of the shooter according to the pre-stored face information;
step 206: setting information of the shooter as unknown;
step 207: displaying the information of the shooter on a viewfinder;
step 208: merging the information of the shooter into the image of the object to generate an image having the information of the shooter and information of the object.

In this example, the face information of the shooter may be pre-stored. For example, an image of the shooter may be shot and stored as the face information of the shooter by the electronic device in advance (e.g., several days ago). Or, the face information sent by other device may be acquired through a communication interface and then stored. For example, the face information may be acquired through email, social networking software, etc., or the registered image may be acquired through Bluetooth, Universal Serial Bus (USB) or NFC. The present application is not limited thereto, and any way for acquiring the face information may be used.

In this example, the pre-stored face information is one-by-one corresponding to the pre-stored information. For example, after the face information of the shooter is matched with the pre-stored face information, pre-stored information corresponding to the pre-stored face information is taken as the information of the shooter. The pre-stored information includes one or any combination of the shooter's registered icon, the shooter's name and the shooter's personalized settings which are usually pre-registered and stored by the shooter.

In step 203, face recognition is performed according to a real-time image of the shooter acquired by the front camera, to acquire the face information of the shooter, which may include the facial features of the shooter. In step 204, the face information of the shooter is compared with the pre-stored face information to determine whether a face in the real-time image is existing in the pre-registered and stored faces. In step 205, pre-stored information corresponding to the face is acquired as the information of the shooter when it is determined that the face in the real-time image is existing in the pre-registered and stored faces;
in which, the comparison may perform mode recognition according to the facial features of the face, or set a match threshold and determine that the face in the real-time image of the shooter is matched with the pre-registered and stored face when a match similarity exceeds the threshold. For example, the threshold may be preset as 80%, and when the similarity between the pre-registered and stored face and the face in the real-time image of the shooter is recognized as 82% through the face recognition technology, it is determined that the face in the real-time image of the shooter is matched with the pre-registered and stored face; and when the similarity between the pre-registered and stored face and the face in the real-time image of the shooter is recognized as 42% through the face recognition technology, it is determined that the face in the real-time image of the shooter is unmatched with the pre-registered and stored face.

The comparison between the real-time image and the pre-stored image is just schematically described as above, but the present application is not limited thereto, and the specific comparison mode may be determined according to the actual conditions. In addition, when it is determined in step 206 that the face in the real-time image of the shooter is unmatched with the pre-registered and stored face, the acquired information of the shooter is unknown, which may be added as the information of the shooter into the image of the object.

In this example, adding information of the shooter into the image of the object to generate a composite image having the information of the shooter and the information of the object may include: adding the information of the shooter into an Exchangeable Image File (EXIF) of the image of the object; or adding the information of the shooter into an EXIF of the image of the object, and embedding an image of the shooter acquired by the front camera into the image of the object;
in which, for example, the information of the shooter may be added into a Maker note of the EXIF of the image of the object. The relevant art may be used to implement the method for adding the information of the shooter into the EXIF of the image of the object, or the method for embedding the image of the shooter into the image of the object, which is omitted herein.

In another example of this embodiment, the image generation element may be a camera of the electronic device, through which the object is shot to generate the image of the object, while the information of the shooter is acquired through for example the sound recognition technology.

This example differs from the previous example in that the electronic device does not need the double cameras, while a microphone and a sound recognition element may be provided. Thus, the face recognition is unnecessary, instead, a comparison between the audio information of the shooter and the pre-registered and stored audio information is performed, and if they are matched, the information of the shooter is acquired according to the pre-stored information.

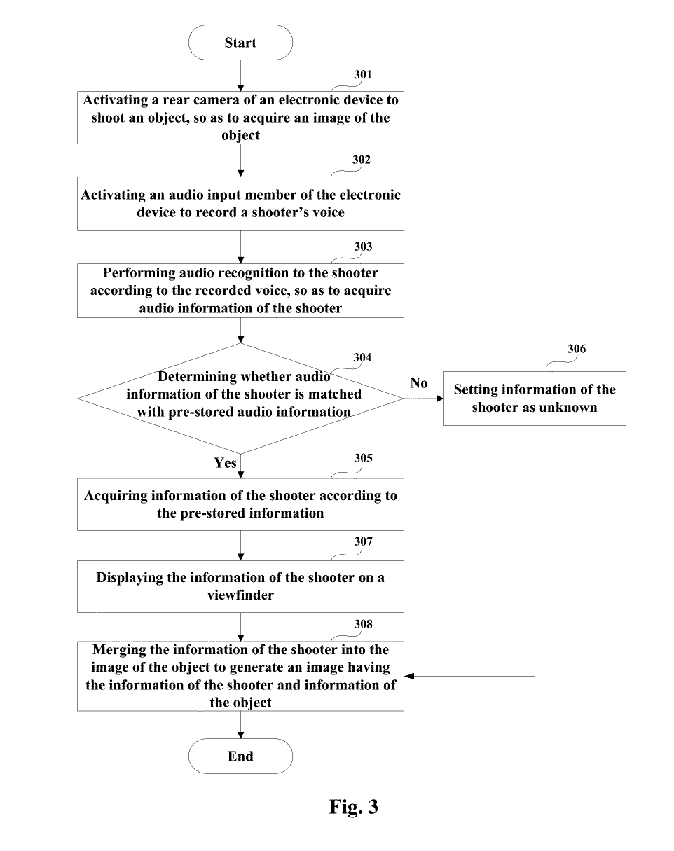

FIG. 3 is still another flowchart of an image processing method according to Embodiment 1 of the present application. As illustrated in FIG. 3, the image processing method includes:
step 301: activating a camera of an electronic device to shoot an object, so as to acquire an image of the object;
step 302: activating an audio input element of the electronic device to record a shooter's voice;
step 303: performing audio recognition to the shooter according to the recorded voice, so as to acquire audio information of the shooter;

For example, when the object is shot with a camera, the shooter may input an audio such as “I'm the shooter” through a microphone. Next, voice recognition may be performed for the audio to acquire the information of the shooter. The voice recognition may be performed with the relevant art, and other steps for acquiring the information of the shooter are the same as those in the previous example, which are omitted herein.
step 304: comparing audio information of the shooter with pre-stored audio information; and if they are matched, performing step 305, otherwise performing step 306;
step 305: acquiring information of the shooter according to the pre-stored information;
step 306: setting information of the shooter as unknown;
step 307: displaying the information of the shooter on a viewfinder;
step 308: merging the information of the shooter into the image of the object to generate an image having the information of the shooter and information of the object.

In this example, adding information of the shooter into the image of the object to generate a composite image having the information of the shooter and the information of the object may include: adding the information of the shooter into an EXIF of the image of the object;
in which, for example, the information of the shooter may be added into a Maker note of the EXIF of the image of the object. The relevant art may be used to implement the method for adding the information of the shooter into the EXIF of the image of the object, which is omitted herein.

In another example, the shooter's usage habit may be recognized to acquire the shooter's usage habit information, which is compared with pre-stored usage habit information to acquire the information of the shooter according to the comparison result.

For example, in the shooting process, the following information is acquired according to the rear camera or other sensing element: whether the shooter clicks the shoot button with his left hand or right hand, whether the middle finger or the index finger touches the shoot button on the screen, and the time span of the touch between the finger and the screen. After the above information of the shooter is acquired by the electronic device, it is compared with the pre-stored shooter's usage habit information to determine the shooter's identity.

For another example, due to physical conditions, a person cannot make a shooting by holding the cellular phone completely vertically, thus the shooter can be determined according to the inclination angle of the device used during the shooting. That is, the following information can be acquired through elements such as a gravity sensor during the shooting: the inclination angle of the cellular phone, for example including the inclination angles in two directions, e.g., the inclination angle in the vertical direction and the inclination angle in the horizontal direction. After acquiring the above information of the shooter, the electronic device compares it with pre-stored shooter's usage habit information.

For still another example, user A is professional in shooting, so he usually selects the Manual Mode and adjusts many settings (e.g., exposure compensation, HDR, a metering mode, an AF mode, etc.). But user B is not familiar with the settings, so he always uses the Auto Mode and the settings are all of default values. After acquiring the above information of the shooter, the electronic device compares it with pre-stored shooter's usage habit information to determine the shooter's identity.

To be noted, how to acquire the information of the shooter by the present application is just described through the face recognition, the voice recognition and the usage habit, but the present application is not limited thereto. Other recognition technology, such as fingerprint recognition, iris recognition, etc., may be used to acquire the information of the shooter, which may be determined according to the actual condition.

In this embodiment, as illustrated in FIG. 2 or 3, in step 207 or 307 the information of the shooter may be displayed on the viewfinder. For example, the registered avatar and/or the name of the shooter may be displayed at the upper left corner of the viewfinder of the electronic device, and/or the icon of the shooter's personalized setting may be displayed at the lower right corner of the viewfinder. Thus, the shooting process may be more enjoyable to greatly meet the shooter's feeling of pleasure, thereby achieving better user experience.

In this embodiment, the image processing method may further include activating the shooter's personalized setting to acquire a personalized-processed image of the object. For example, some shooters will not turn on the flash even if the ambient light is weak, some shooters will not activate the shutter sound, etc. Thus, the shooting mode required by the shooter can be quickly started to simplify the tedious mode setting operation and achieve better user experience.

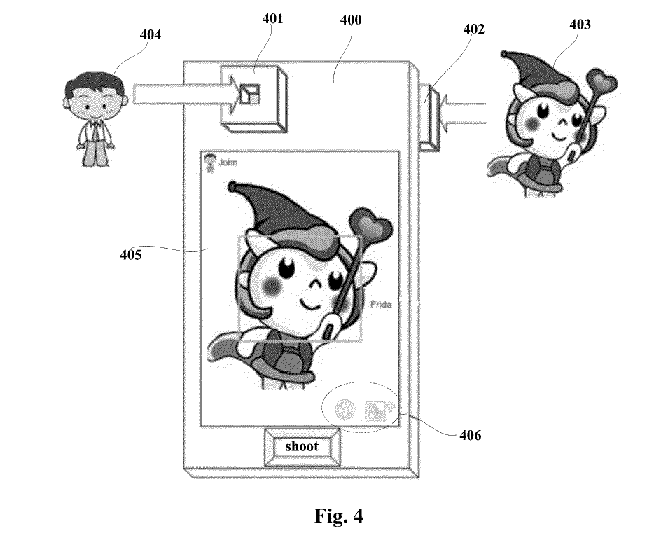

FIG. 4 is a diagram of an example of acquiring information of the shooter according to Embodiment 1 of the present application, which illustrates the present application through an example where double cameras are used. As illustrated in FIG. 4, an electronic device 400 includes a front camera 401 and a rear camera 402, wherein an object 403 (Frida) is shot through the rear camera 402 to generate an image of Frida, and information of a shooter 404 (John) is acquired through the front camera 401.

Firstly, the front camera 401 and the rear camera 402 may be started simultaneously, wherein the front camera 401 acquires an image of John and then performs face recognition, and the rear camera 402 displays the image of Frida on a viewfinder 405. Next, when the face information of John is matched with the pre-stored face information, pre-stored information of John is acquired, including the registered icon, name and personalized settings of John; wherein the registered icon and name of John are displayed at the upper left corner of the viewfinder 405 to indicate that the front camera 401 recognizes John; in that case, the personalized settings 406 of John are displayed at the lower right corner of the viewfinder 405, such as deactivating the flash and activating HDR.

Meanwhile, face recognition can be performed after the rear camera 402 acquires the image of Frida. In a case where the rear camera 402 recognizes Frida, the name of Frida may be displayed near the image of Frida (i.e., the image of the object) on the viewfinder 405, and the face of Frida may be focused preferentially.

Finally, after the shooting, the name and icon of John are added to the Maker note of the EXIF of the generated image of Frida; or the name and icon of John are added to the Maker note of the EXIF of the generated image of Frida, and the image of John acquired by the front camera 401 is added as a watermark into the image of Frida.

To be noted, the present application is just described as above by taking static images (pictures) as an example. But the present application is not limited thereto, and for example may be applied to the shooting of dynamic images (videos). In addition, the acquired information of the shooter may be edited, modified, etc. For example, before a shooting is ended, the user may be allowed to confirm the modification of the information of the shooter; the modification or edition may be completed through a man-machine interaction interface; or the information of the shooter may be modified by selecting a picture in an image processing software (e.g., Album or Gallery) after the shooting is completed.

As can be seen from the above embodiment, by adding the information of the shooter into the image of the object, the information of both the shooter and the object can be conveniently acquired, thereby reducing a lot of tedious and repetitive operations, and achieving better user experience. In addition, the shooting process may be more enjoyable to greatly meet the shooter's feeling of pleasure.

### Embodiment 2

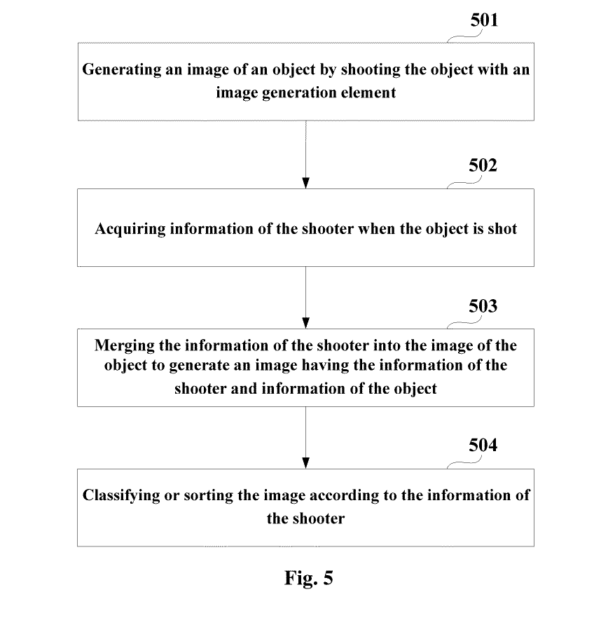

The embodiment of the present application provides an image processing method, which is further described on the basis of Embodiment 1. FIG. 5 is a flowchart of an image processing method according to Embodiment 2 of the present application. As illustrated in FIG. 5, the image processing method includes:
step 501: generating an image of an object by shooting the object with an image generation element;
step 502: acquiring information of the shooter when shooting the object;
step 503: merging the information of the shooter into the image of the object to generate an image having the information of the shooter and information of the object;
step 504: classifying or sorting the image according to the information of the shooter.

In this embodiment, steps 501 and 503 may be implemented in the same way as steps 101 and 103 in Embodiment 1, and herein are omitted. After acquiring the information of the shooter, the image processing method may further include displaying the information of the shooter on the viewfinder of the image generation element. The image processing method may further include activating the shooter's personalized settings to acquire the personalized-processed image of the object.

In step 504, the information of the shooter added into the image of the object may be extracted by a gallery application program of the electronic device, so as to classify or sort a composite image based on the shooter; in which, when step 502 does not acquire the information of the shooter, i.e., the acquired information of the shooter is unknown, the composite image may be classified into an unknown class.

Thus, by adding the information of the shooter into the image of the object, this embodiment increases the classes for image classification or sorting, so that an image can be classified or sorted conveniently according to the information of the shooter, and the shooter's contribution to the image is also confirmed from one aspect, thereby achieving better user experience.

For example, as illustrated in FIG. 4, after the name of John is added into the Maker note of the EXIF of the generated image of Frida, the image of Frida added with the name of John may be classified or sorted according to the name of John, so as to facilitate image classification or sorting.

In this embodiment, the image processing method may further include: acquiring information of the object by recognizing the object (in the above face recognition method), thereby further associating the shooter with the object.

In this embodiment, the image processing method may further include: sending the information of the shooter and the information of the object to a server, so as to establish the shooter's link information or establish associations between a plurality of shooters who shoot the object in the server.

In one example, the information of the shooter, the information of the object and the image may be sent to a cloud server, so as to establish the shooter's link information in the cloud server. Thus, another user can obtain the information of the object when browsing the image, and be associated with the shooter through the shooter's link information.

In another example, the information of the shooter, the information of the object and the image may be sent to a cloud server, so as to establish associations between a plurality of shooters who shoot the object in the cloud server.

For example, both John and Mike shoot the Golden Gate Bridge, then John and Mike may be associated with each other through the images and added into the same circle of hobbies. When John browses the image of the Golden Gate Bridge taken by himself, the electronic device may prompt that Mike also shoots the Golden Gate Bridge and suggests John to view the image taken by Mike. In this way, John and Mike can view the works of each other.

In addition, the server may count the rule of the images shot by John (e.g., whether persons are mostly shot or where the sceneries are shot), and compare it with the shooting rule of other people. If John and Mike often shoot sceneries and the shooting locations are mostly overlapped, then after John shoots an image, the electronic device prompts John that Mike has the similar photography hobby and also has been to the same location, and provides Mike's related information or link

In another example, the information of the shooter, the information of the object and the image may be sent to a cloud server, so as to establish associations between a plurality of shooters who shoot the object in the cloud server.

For example, when the copyright of the image is owned by the shooter John, other shooters who shoot the image may be prompted that the copyright of the image is owned by John. For example, after Mike shoots an image, the server compares the image with other images, and if an image having a similarity of more than 90% is matched (e.g., in the server, the image having that high similarity is shot by John), the electronic device prompts Mike “somebody has shot a similar image, and please pay attention to the copyright”, and provides the thumbnail or link of the image shot by John.

To be noted, how to apply the image having the information of the shooter and the information of the object is just exemplarily described as above, but the present application is not limited thereto, and the application mode may be determined according to the specific scene.

As can be seen from the above embodiment, by adding the information of the shooter into the image of the object, the information of both the shooter and the object can be conveniently acquired, and the image can be conveniently classified or sorted according to the information of the shooter, thereby reducing a lot of tedious and repetitive operations, and achieving better user experience. In addition, the shooting process may be more enjoyable to greatly meet the shooter's feeling of pleasure.

### Embodiment 3

The embodiment of the present application provides an image processing apparatus, which is corresponding to the image processing method as described in Embodiment 1, and the same contents are omitted herein.

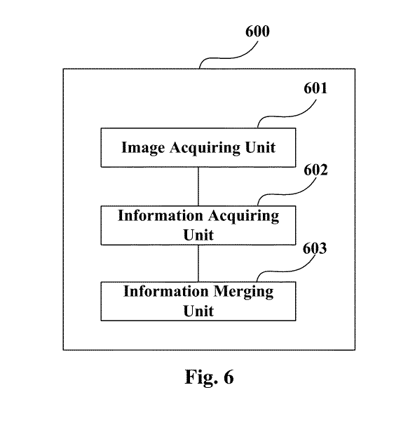

FIG. 6 is a schematic diagram of the structure of an image processing apparatus according to Embodiment 3 of the present application. As illustrated in FIG. 6, an image processing apparatus 600 includes: an image acquiring unit 601, an information acquiring unit 602 and an information merging unit 603;
in which, the image acquiring unit 601 is configured to generate an image of an object by shooting the object with an image generation element; the information acquiring unit 602 is configured to acquire information of a shooter when the object is shot; and the information merging unit 603 is configured to merge the information of the shooter into the image of the object to generate an image having the information of the shooter and information of the object.

In this embodiment, the information of the shooter can be acquired when the object is shot. For example, the information of the shooter can be acquired in real time with a camera; in which, the image generation element is a rear camera, and the information acquiring unit 602 acquires the information of the shooter through a front camera. Thus, not only information of the shooter and the object can be reflected, but also a lot of tedious and repetitive operations such as user authentication can be reduced, thereby achieving better user experience. But the present application is not limited thereto, and the information of the shooter can be acquired in other ways, such as voice recognition.

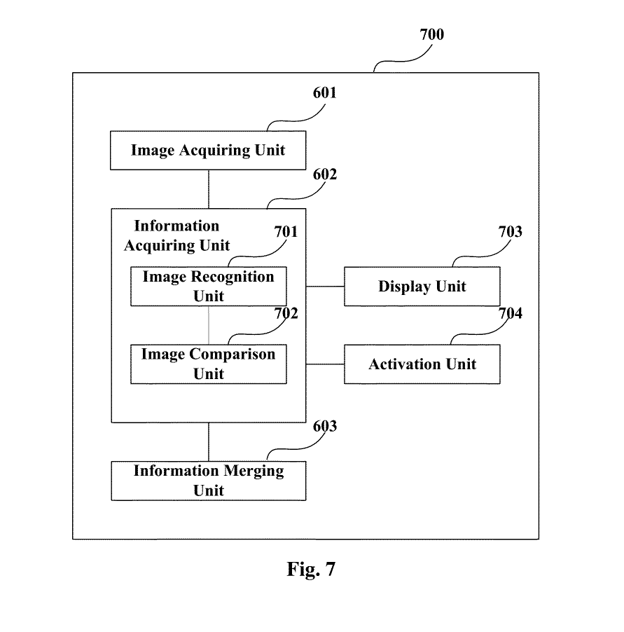

In one example, the information of the shooter can be acquired through face recognition. FIG. 7 is another schematic diagram of the structure of an image processing apparatus according to Embodiment 3 of the present application. As illustrated in FIG. 7, an image processing apparatus 700 includes an image acquiring unit 601, an information acquiring unit 602 and an information merging unit 603 as described above.

As illustrated in FIG. 7, the information acquiring unit 602 may include: an image recognition unit 701 and an image comparison unit 702, wherein the image recognition unit 701 is configured to perform face recognition of the shooter to acquire face information of the shooter, and the image comparison unit 702 is configured to compare the face information of the shooter with pre-stored face information to acquire the information of the shooter according to a comparison result.

In this example, the information merging unit 603 may be configured to add the information of the shooter into an EXIF of the image of the object; or add the information of the shooter into an EXIF of the image of the object, and embed an image of the shooter acquired by the front camera into the image of the object.

As illustrated in FIG. 7, the image processing apparatus 700 may further include: a display unit 703 configured to display the information of the shooter on the viewfinder of the electronic device. Thus, the shooting process may be more enjoyable to greatly meet the shooter's feeling of pleasure, thereby achieving better user experience.

As illustrated in FIG. 7, the image processing apparatus 700 may further include: an activation unit 704 configured to activate the shooter's personalized settings to acquire a personalized-processed image of the object. Thus, the shooting mode required by the shooter can be quickly started to simplify the tedious mode setting operation and achieve better user experience.

In this embodiment, the image processing apparatus 700 may further include an information prompt unit (not illustrated) configured to prompt when a face of a real-time image of the shooter is unmatched with a pre-registered and stored face.

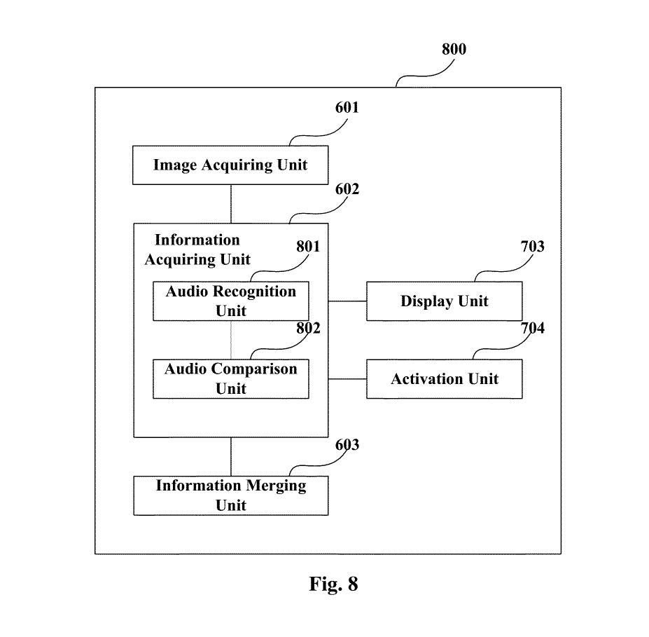

In another example, the information of the shooter may be acquired through audio recognition. FIG. 8 is still another schematic diagram of the structure of an image processing apparatus according to Embodiment 3 of the present application. As illustrated in FIG. 8, the image processing apparatus 800 includes an image acquiring unit 601, an information acquiring unit 602 and an information merging unit 603 as described above.

As illustrated in FIG. 8, the information acquiring unit 602 may include an audio recognition unit 801 and an audio comparison unit 802, wherein the audio recognition unit 801 is configured to perform voice recognition of the shooter to acquire audio information of the shooter, and the audio comparison unit 802 is configured to compare the audio information of the shooter with pre-stored audio information, to acquire the information of the shooter according to a comparison result.

In this example, the information merging unit 603 is configured to embed the information of the shooter into the EXIF of the image of the object. In addition, as illustrated in FIG. 8, the image processing apparatus 800 may further include a display unit 703, an activation unit 704 and an information prompt unit, as described above.

In another example, the information acquiring unit 602 may recognize the shooter's usage habit, to acquire the shooter's usage habit information; and compare the shooter's usage habit information with pre-stored usage habit information, to acquire the in- formation of the shooter according to a comparison result.

As can be seen from the above embodiment, by adding the information of the shooter into the image of the object, the information of both the shooter and the object can be conveniently acquired, thereby reducing a lot of tedious and repetitive operations, and achieving better user experience. In addition, the shooting process may be more enjoyable to greatly meet the shooter's feeling of pleasure.

### Embodiment 4

The embodiment of the present application provides an image processing apparatus, which is corresponding to the image processing method as described in Embodiment 2. This embodiment is further described on the basis of Embodiment 3, and the same contents are omitted herein.

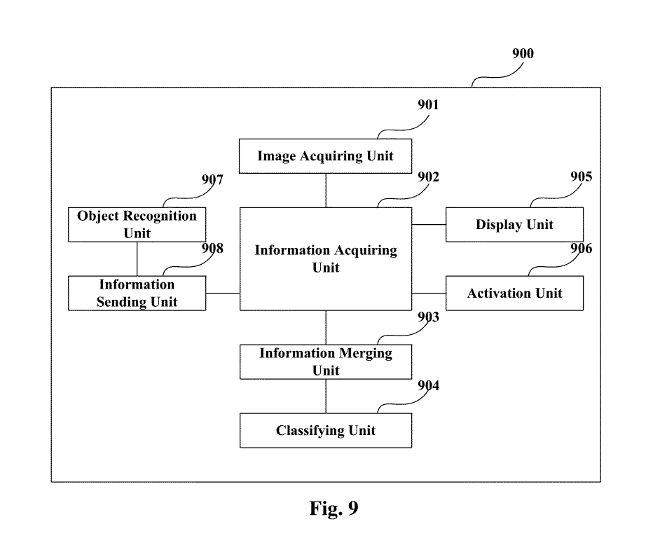

FIG. 9 is a schematic diagram of the structure of an image processing apparatus according to Embodiment 4 of the present application. As illustrated in FIG. 9, the image processing apparatus 900 includes an image acquiring unit 901, an information acquiring unit 902, an information merging unit 903 and a classifying unit 904; in which, the image acquiring unit 901 is configured to generate an image of an object by shooting the object with an image generation element; the information acquiring unit 902 is configured to acquire information of a shooter when the object is shot; the information merging unit 903 is configured to merge the information of the shooter into the image of the object to generate an image having the information of the shooter and information of the object; and the classifying unit 904 is configured to classify or sort the composite image according to the information of the shooter

In this embodiment, the image acquiring unit 901, the information acquiring unit 902 and the information merging unit 903 respectively have the same structures and functions as the image acquiring unit 601, the information acquiring unit 602 and the information merging unit 603 in Embodiment 3, and herein are omitted.

In this embodiment, the classifying unit 904 may extract the information of the shooter added into the image of the object with a gallery application program of the electronic device, so as to classify or sort the composite image based on the shooter; in which, when the information acquiring unit 902 does not acquire the information of the shooter, i.e., the acquired information of the shooter is unknown, the composite image may be classified into an unknown class.

Thus, this embodiment increases the classes for image classification or sorting, so that an image can be classified or sorted conveniently according to the information of the shooter, and the shooter's contribution to the image is also confirmed from one aspect, thereby achieving better user experience.

In this embodiment, as illustrated in FIG. 9, the image processing apparatus 900 may further include: a display unit 905 configured to display the information of the shooter on the viewfinder of the electronic device. Thus, the shooting process may be more enjoyable to greatly meet the shooter's feeling of pleasure, thereby achieving better user experience.

As illustrated in FIG. 9, the image processing apparatus 900 may further include an activation unit 906 configured to activate the shooter's personalized settings to acquire a personalized-processed image of the object. Thus, the shooting mode required by the shooter can be quickly started to simplify the tedious mode setting operation and achieve better user experience.

In this embodiment, the image processing apparatus 900 may further include an information prompt unit (not illustrated) configured to prompt when a face of a real-time image of the shooter is unmatched with a pre-registered and stored face.

As illustrated in FIG. 9, the image processing apparatus 900 may further include an object recognition unit 907 configured to recognize the object to acquire information of the object.

As illustrated in FIG. 9, the image processing apparatus 900 may further include an information sending unit 908 configured to send the information of the shooter and the information of the object to the server, so as to establish the shooter's link information or associations between a plurality of shooters who shoot the object in the server.

As can be seen from the above embodiment, by adding the information of the shooter into the image of the object, the information of both the shooter and the object can be conveniently acquired, and the image can be conveniently classified or sorted according to the information of the shooter, thereby reducing a lot of tedious and repetitive operations, and achieving better user experience. In addition, the shooting process may be more enjoyable to greatly meet the shooter's feeling of pleasure.

### Embodiment 5

The embodiment of the present application provides an electronic device which controls an image generation element (such as camera, lens, etc.). The electronic device may be a smart phone, a photo camera, a video camera, a tablet computer, etc., but the embodiment of the present application is not limited thereto.

In this embodiment, the electronic device may include an image generation element, and an image processing apparatus according to Embodiment 3 or 4, which are incorporated herein, and the repeated contents are omitted.

In this embodiment, the electronic device may be a mobile terminal, but the present application is not limited thereto.

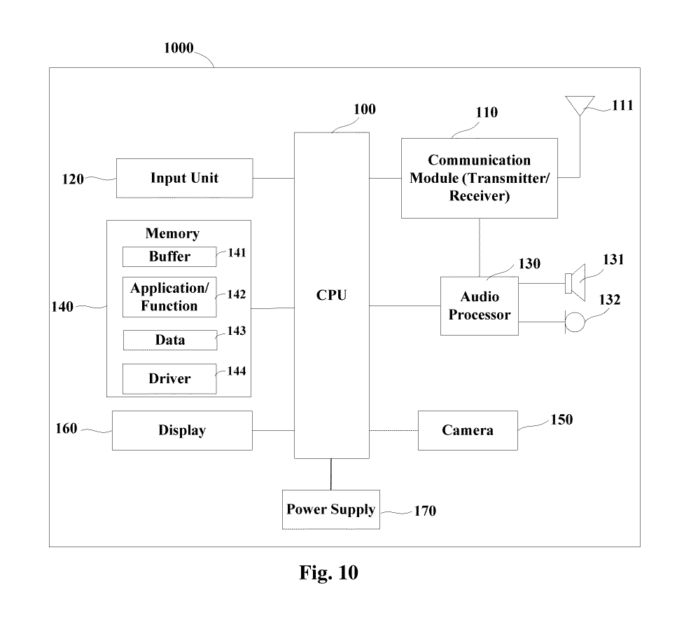

FIG. 10 is a block diagram of a system construction of an electronic device according to Embodiment 5 of the present application. The electronic device 1000 may include a central processing unit (CPU) 100 and a memory 140 coupled to the CPU 100. To be noted, the diagram is exemplary, and other type of structure may also be used to supplement or replace the structure, so as to realize the telecom function or other function.

In one example of this embodiment, the function of any of the image processing apparatuses 600 to 900 may be integrated into the CPU 100; in which, the CPU 100 may be configured to acquire information of a shooter when an object is shot with an image generation element; and merge the information of the shooter into an image of the object generated by shooting the object to generate an image having the information of the shooter and information of the object.

Or, the CPU 100 may be configured to acquire information of a shooter when an object is shot with an image generation element; merge the information of the shooter into an image of the object generated by shooting the object to generate an image having the information of the shooter and information of the object; and classify or sort the composite image according to the information of the shooter;
in which, the information of the shooter may include one or any combination of the shooter's identity, the shooter's name, the shooter's link information, the shooter's social network information and the shooter's personalized settings.

The CPU 100 may be further configured to shoot the object through a first camera, and acquire the information of the shooter through a second camera.

The CPU 100 may be further configured to display the information of the shooter on a viewfinder.

The CPU 100 may be further configured to activate the shooter's personalized settings to acquire a personalized-processed image of the object.

In another example of this embodiment, any of the image processing apparatuses 600 to 900 may be separated from the CPU 100. For example, the image processing apparatus 600 may be configured as a chip connected to the CPU 100, and the function of the image processing apparatus 600 is realized through the control of the CPU 100.

As illustrated in FIG. 10, the electronic device 1000 may further include a communication module 110, an input unit 120, an audio processor 130, a camera 150, a display 160 and a power supply 170.

The CPU 100 (sometimes called as controller or operation control, including micro-processor or other processor device and/or logic device) receives an input and controls respective parts and operations of the electronic device 1000. The input unit 120 provides an input to the CPU 100. The input unit 120 for example is a key or a touch input device. The camera 150 captures image data and supplies the captured image data to the CPU 100 for a conventional usage, such as storage, transmission, etc.

The power supply 170 supplies electric power to the electronic device 1000. The display 160 displays objects such as images and texts. The display may be, but not limited to, an LCD.

The memory 140 may be a solid state memory, such as Read Only Memory (ROM), Random Access Memory (RAM), SIM card, etc., or a memory which stores information even if the power is off, which can be selectively erased and provided with more data, and the example of such a memory is sometimes called as EPROM, etc. The memory 140 also may be a certain device of other type. The memory 140 includes a buffer memory 141 (sometimes called as buffer). The memory 140 may include an application/function storage section 142 which stores application programs and function programs or performs the operation procedure of the electronic device 1000 via the CPU 100.

The memory 140 may further include a data storage section 143 which stores data such as contacts, digital data, pictures, sounds, pre-stored information of the shooter, pre-stored information of the object and/or any other data used by the electronic device. A drive program storage section 144 of the memory 140 may include various drive programs of the electronic device for performing the communication function and/or other functions (e.g., message transfer application, address book application, etc.) of the electronic device.

The communication module 110 is a transmitter/receiver 110 which transmits and receives signals via an antenna 111. The communication module (transmitter/receiver) 110 is coupled to the CPU 100, so as to provide an input signal and receive an output signal, which may be the same as the situation of conventional mobile communication terminal.

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 and a microphone 132 via an audio processor 130, so as to provide an audio output via the speaker 131, and receive an audio input from the microphone 132, thereby performing the normal telecom function. The audio processor 130 may include any suitable buffer, decoder, amplifier, etc. In addition, the audio processor 130 is further coupled to the CPU 100, so as to locally record sound through the microphone 132, and play the locally stored sound through the speaker 131.

The embodiment of the present application further provides a computer readable program, which when being executed in an electronic device, enables a computer to perform the image processing method according to Embodiment 1 or 2 in the electronic device.

The embodiment of the present application further provides a storage medium storing a computer readable program, wherein the computer readable program enables a computer to perform the image processing method according to Embodiment 1 or 2 in an electronic device.

The preferred embodiments of the present application are described as above with reference to the drawings. Many features and advantages of those embodiments are apparent from the detailed Specification, thus the accompanied claims intend to cover all such features and advantages of those embodiments which fall within the true spirit and scope thereof. In addition, since numerous modifications and changes are easily conceivable to a person skilled in the art, the embodiments of the present application are not limited to the exact structures and operations as illustrated and described, but cover all suitable modifications and equivalents falling within the scope thereof.

It shall be understood that each of the parts of the present application may be implemented by hardware, software, firmware, or combinations thereof. In the above embodiments, multiple steps or methods may be implemented by software or firmware stored in the memory and executed by an appropriate instruction executing system. For example, if the implementation uses hardware, it may be realized by any one of the following technologies known in the art or combinations thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

Any process, method or block in the flowchart or described in other manners herein may be understood as being indicative of including one or more modules, segments or parts for realizing the codes of executable instructions of the steps in specific logic functions or processes, and that the scope of the preferred embodiments of the present application include other implementations, wherein the functions may be executed in manners different from those shown or discussed (e.g., according to the related functions in a substantially simultaneous manner or in a reverse order), which shall be understood by a person skilled in the art.

The logic and/or steps shown in the flowcharts or described in other manners here may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal descriptions and drawings show various features of the present application. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present application by using the apparatus.

Particular embodiments of the present application have been disclosed herein. A person skilled in the art will readily recognize that the present application is applicable in other environments. In practice, there exist many embodiments and implementations. The appended claims are by no means intended to limit the scope of the present application to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present application has been described, it is will be appreciated that equivalent modifications and variants are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present application with respect to structure. Furthermore, although the a particular feature of the present application is described with respect to only one or more of the illustrated embodiments, such a feature may be combined with one or more other features of other embodiments as desired and in consideration of advantageous aspects of any given or particular application.

1. An image processing method, comprising:
generating an image of an object by shooting the object with an image generation element;
acquiring information of a shooter when the object is shot; and
merging the information of the shooter into the image of the object to generate an image having the information of the shooter and information of the object.

2. The image processing method according to claim 1, wherein the image generation element is a first camera, and the information of the shooter is acquired through a second camera.

3. The image processing method according to claim 1, wherein the acquiring information of a shooter when the object is shot comprises:
performing face recognition of the shooter to acquire face information of the shooter; and comparing the face information of the shooter with pre-stored face information to acquire the information of the shooter according to a comparison result;
or, performing voice recognition of the shooter to acquire audio information of the shooter; and comparing the audio information of the shooter with pre-stored audio information to acquire the information of the shooter according to a comparison result;
or, recognizing the shooter's usage habit to acquire the shooter's usage habit information; and comparing the shooter's usage habit information with pre-stored usage habit information to acquire the information of the shooter according to a comparison result.

4. The image processing method according to claim 1, wherein the information of the shooter comprises one or any combination of the shooter's identity, the shooter's name, the shooter's link information, the shooter's social network information and the shooter's personalized settings.

5. The image processing method according to claim 1, wherein after the acquiring information of a shooter by the object is shot, the image processing method further comprises:
displaying the information of the shooter on a viewfinder.

6. The image processing method according to claim 5, further comprising:
activating the shooter's personalized settings to acquire a personalized-processed image of the object.

7. The image processing method according to claim 2, wherein the merging the information of the shooter into the image of the object to generate an image having the information of the shooter and information of the object comprises:
adding the information of the shooter into an Exchangeable Image File (EXIF) of the image of the object; or
adding the information of the shooter into an EXIF of the image of the object, and embedding an image of the shooter acquired by the second camera into the image of the object.

8. The image processing method according to claim 1, wherein after the merging the information of the shooter into the image of the object to generate an image having the information of the shooter and information of the object, the image processing method further comprises:
classifying or sorting the image according to the information of the shooter.

9. The image processing method according to claim 1, further comprising:
recognizing the object to acquire the information of the object.

10. The image processing method according to claim 1, further comprising:
sending the information of the shooter and the information of the object to a server, so as to establish the shooter's link information or associations between a plurality of shooters who shoot the object in the server.

11. An image processing apparatus, comprising:
an image acquiring unit configured to generate an image of an object by shooting the object with an image generation element;
an information acquiring unit configured to acquire information of a shooter when the object is shot; and
an information merging unit configured to merge the information of the shooter into the image of the object to generate an image having the information of the shooter and information of the object.

12. The image processing apparatus according to claim 11, wherein the image generation element is a first camera, and the information acquiring unit acquires the information of the shooter through a second camera.

13. The image processing apparatus according to claim 11, wherein the information acquiring unit is configured to perform face recognition of the shooter to acquire face information of the shooter, and compare the face information of the shooter with pre-stored face information to acquire the information of the shooter according to a comparison result;
or, perform voice recognition of the shooter to acquire audio information of the shooter; and compare the audio information of the shooter with pre-stored audio information to acquire the information of the shooter according to a comparison result;
or, recognize the shooter's usage habit to acquire the shooter's usage habit information; and compare the shooter's usage habit information with pre-stored usage habit information to acquire the information of the shooter according to a comparison result.

14. The image processing apparatus according to claim 11, further comprising:
a display unit configured to display the information of the shooter on a viewfinder.

15. The image processing apparatus according to claim 11, further comprising:
an activation unit configured to activate the shooter's personalized settings to acquire a personalized-processed image of the object.

16. The image processing apparatus according to claim 12, wherein the information merging unit is configured to add the information of the shooter into an Exchangeable Image File (EXIF) of the image of the object; or add the information of the shooter into an EXIF of the image of the object, and embed an image of the shooter acquired by the second camera into the image of the object.

17. The image processing apparatus according to claim 11, further comprising:
a classifying unit configured to classify or sort the image according to the information of the shooter.

18. The image processing apparatus according to claim 11, further comprising:
an object recognition unit configured to recognize the object to acquire the information of the object.

19. The image processing apparatus according to claim 18, further comprising:
an information sending unit configured to send the information of the shooter and the information of the object to a server, so as to establish the shooter's link information or associations between a plurality of shooters who shoot the object in the server.

20. An electronic device, comprising the image processing apparatus according to claim 11.
